(19) United States
(12) Patent Application Publication
(10) Pub. No.: US 2017/0034625 A1
(43) Pub. Date: Feb. 2, 2017

(54) ELECTRONIC DEVICE HAVING A MODE DAMPED DIAPHRAGM

(71) Applicant: Logitech Europe S.A, Lausanne (CH)

(72) Inventor: Adam Tracy WICK, Vancouver, WA (US)

(21) Appl. No.: 15/055,489

(22) Filed: Feb. 26, 2016

Related U.S. Application Data
(60) Provisional application No. 62/199,936, filed on Jul. 31, 2015.

(51) Int. Cl. H04R 7/02; H04R 1/10

(52) U.S. Cl. CPC H04R 7/02; H04R 1/1091

(57) ABSTRACT

The present disclosure generally provides an apparatus and method of forming an audio speaker that has an improved sound quality over conventional audio speaker designs and has a low manufacturing cost. In an effort to overcome the shortcomings of conventional sealed speaker designs that typically have diaphragms that generate undesirable levels of distortion, one or more of the embodiments of the disclosure provided herein include a speaker diaphragm that is formed from a mode damped diaphragm design. In general, a mode damped diaphragm is configured to damp the various mode shapes generated during the delivery of an acoustic output from the speaker assembly. It is believed that one or more of the embodiments of the disclosure provided herein could be used in any audio speaker application, but may provide additional advantages when used in various headphone, headset, earphone or in-ear monitor type applications.

### CROSS-REFERENCE TO RELATED APPLICATIONS

This application claims priority to U.S. Provisional Patent Application Ser. No. 62/199,936, filed on Jul. 31, 2015, which is herein incorporated by reference.

### BACKGROUND

Field

Embodiments of the present disclosure generally relate to an electronic device, and more specifically to an apparatus and method of using an electronic device that is configured to deliver audio information through a speaker.

Description of the Related Art

An important feature in an audio speaker design is sound quality. With the advent of mobile media players, such as smart phones, iPods®, and other devices, there has been an effort to develop audio speakers (e.g., acoustic transducers or drivers) that receive a stream of digital and/or analog information that is translated using various electronic circuit elements into sound via one or more audio speakers. Typically, audio speakers, such as loudspeakers or headphones, include an enclosure and at least one acoustic transducer, or driver, having a diaphragm that produces sound waves by converting an electrical signal into mechanical motion. Sound transducers typically generate sound waves by physically moving air at various frequencies. During operation the sound transducer pushes and pulls a diaphragm in order to create periodic increases and decreases in air pressure, thus creating sound.

Sound quality of an audio speaker can be improved by reducing the amount of distortion which is generated when sounds are reproduced by an audio speaker. One major source of distortion in a speaker is caused by the vibrational modes of the driver diaphragm at different frequencies, such as high frequencies. The amount of distortion within a driver diaphragm can be visualized through scanning laser vibrometry. A diaphragm's vibrational modes at different frequencies can often be seen as a non-smooth acoustical frequency response, which is often viewed by plotting sound power (dB SPL) versus frequency. A diaphragm's acoustic frequency response is often non-smooth in the high frequency range, such as above ˜1 kilohertz (KHz). It is believed that most of the modal distortion of a driver diaphragm comes from the transducer's diaphragm itself. In some sound delivery and hardware configurations, different parts of the diaphragm will move out of phase with each other, at the same moment in time. This undesirable deformation of the driver diaphragm will cause partial and irregular cancellation of the total acoustical output provided from the diaphragm's surface. This type of distortion will occur at all amplitudes and at varying physical angles relative to the center axis of the driver, and can be visualized as sharp discontinuities in the frequency response above the transition frequency.

To solve these types of problems audio device manufacturers have sought to try to stiffen the driver diaphragm in hopes of moving the various distortion modes of the diaphragm to a high enough frequency level that is outside of the normal acoustic range of the audio signal playback range or human hearing range. However, to form these types of mechanically stiff diaphragms may require the use of a thin sheet of an exotic and expensive material, such as beryllium (Be), aluminum (Al) and titanium (Ti) versus the standard low cost paper type diaphragms that have been used for years in the audio industry. These types of stiffer diaphragms are hard to manufacture and are often too costly for use in the consumer electronics market today.

Therefore, there is need for a speaker design that provides a high-quality sound output, has a low manufacturing cost and is easily manufactured. The devices, systems, and methods disclosed herein are designed to overcome the deficiencies described above.

### SUMMARY OF THE INVENTION

Embodiments of the present disclosure may provide an audio speaker assembly, comprising an enclosure comprising one or more walls that at least partially enclose an internal region, a sealing feature that is coupled to the enclosure, and having a sealing surface that forms an enclosed acoustic region when placed in contact with at least a portion of a user, and a speaker that is coupled to the one or more walls. The speaker (e.g., transducer) may comprise a mode damped diaphragm, and a voice coil that is configured to drive the mode damped diaphragm to generate an acoustic pressure in the enclosed acoustic region, wherein the voice coil and mode damped diaphragm are configured to deliver an acoustic output across a first acoustic range.

Embodiments of the present disclosure may provide an audio speaker assembly, comprising an enclosure comprising one or more walls that at least partially enclose an internal region, a sealing feature that is coupled to the enclosure, and having a sealing surface that forms an acoustic region when placed in contact with at least a portion of an ear of a user or a portion of the user surrounding the ear, a port element that defines an opening formed through a first wall of the one or more walls, wherein the opening extends between a first side and a second side of the first wall, a restrictive cap element that is disposed over the opening formed on the first side of the first wall, and a speaker that is coupled to the one or more walls. The speaker may comprise a mode damped diaphragm, and a voice coil that is configured to drive the mode damped diaphragm to generate an acoustic pressure in the enclosed acoustic region, wherein the voice coil and mode damped diaphragm are configured to deliver an acoustic output across a first acoustic range.

Other embodiments include, without limitation, a computer-readable medium that includes instructions that enable a processing unit to implement one or more aspects of the disclosed methods as well as a system configured to implement one or more aspects of the disclosed methods.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side cross-sectional view of an audio speaker assembly, according to an embodiment of the disclosure provided herein.

FIG. 2 is a side cross-sectional view of an audio speaker assembly, according to an embodiment of the disclosure provided herein.

FIG. 3 is a graph illustrating the audio output of a conventional audio speaker and the audio output of a speaker assembly containing a mode damped diaphragm, according to an embodiment of the disclosure provided herein.

FIG. 4 is a graph illustrating the first derivative of the audio output of the conventional audio speaker shown in FIG. 3 and the first derivative of the audio output of the mode damped diaphragm type speaker assembly shown in FIG. 3, according to an embodiment of the disclosure provided herein.

FIG. 5 is a graph illustrating the first derivative data shown in FIG. 4 with a differently scaled ordinate axis, according to an embodiment of the disclosure provided herein.

FIG. 6 illustrates a 3D surface laser vibrometer measurement of a conventional diaphragm in a conventional speaker in free-air at a driven frequency of 10 KHz.

FIG. 7 illustrates a 3D surface laser vibrometer measurement of a mode damped diaphragm in free-air at a driven frequency of 10 KHz.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally provides an apparatus and method of forming an audio speaker that has an improved sound quality over conventional audio speaker designs and has a low manufacturing cost. In an effort to overcome the shortcomings of conventional sealed speaker designs that typically have diaphragms that generate undesirable levels of distortion, one or more of the embodiments of the disclosure provided herein include a speaker diaphragm that includes a mode damped diaphragm that may be used in conjunction with a sealed speaker assembly design. In general, a mode damped diaphragm is configured to damp the various mode shapes of the diaphragm generated during the delivery of an acoustic output from the speaker assembly. It is believed that one or more of the embodiments of the disclosure provided herein could be used in any audio speaker application, but may provide additional advantages when used in various headphone, headset, earphone or in-ear monitor type applications.

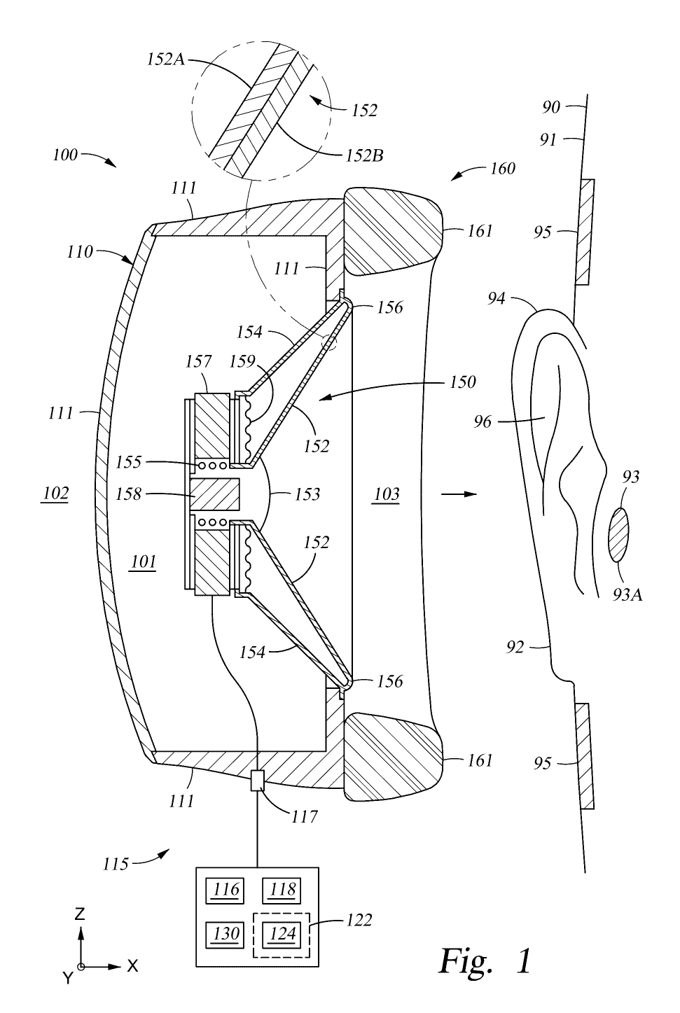

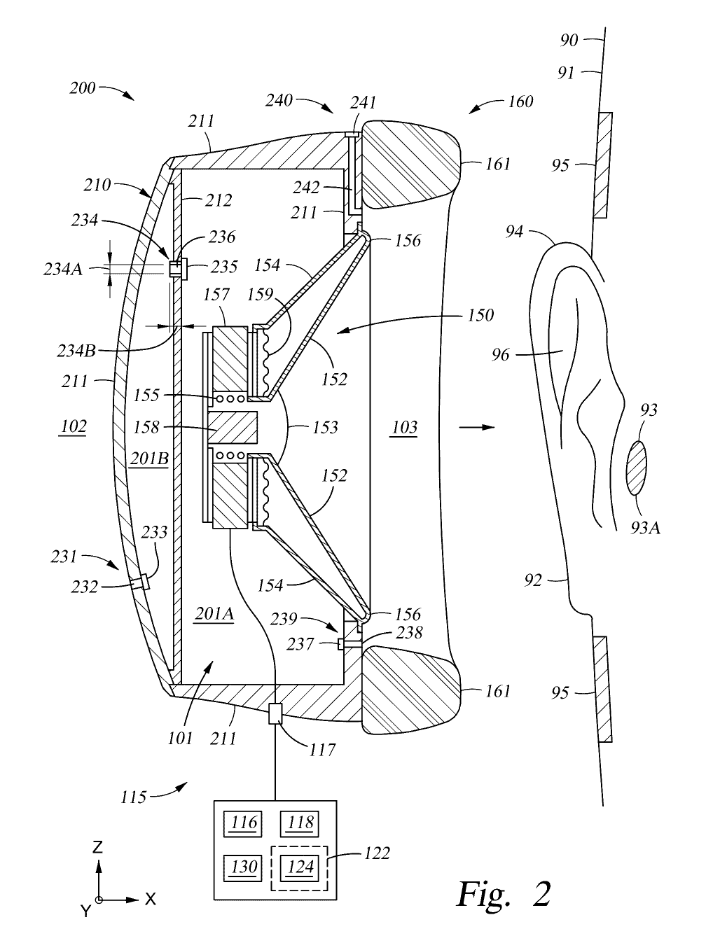

FIG. 1 is a side cross-sectional view that illustrates a sealed or partially sealed active speaker assembly 100, or simply a speaker assembly 100, according to an embodiment of the disclosure provided herein. The speaker assembly 100 includes a speaker enclosure 110, or transducer enclosure 110, that includes a speaker 150 and an amplifier assembly 115. The speaker enclosure 110 also includes one or more walls 111 that enclose an internal region 101 that is separated from an acoustic region 103 and an external region 102. One skilled in the art will appreciate that, while not shown in FIGS. 1 and 2, the speaker assemblies 100 or 200 may each include both active and passive components. The audio speaker assembly configurations disclosed herein may be used to form many different types of audio generating devices, such as headphones, headsets, earphones, in-ear monitors, or other similar devices.

The speaker 150, which is disposed between the internal region 101 and acoustic region 103, generally includes a mode damped diaphragm 152, a frame 154, a surround 156, a voice coil 155, a pole piece 158, a permanent magnet 157, a dust cover 153 and an optional spider 159. The speaker 150 is typically sealably mounted to a wall 111 of the speaker enclosure 110 to physically isolate and/or separate the internal region 101 and acoustic region 103. During operation, the amplifier assembly 115 delivers a signal to the speaker 150, which causes the voice coil 155 to move the mode damped diaphragm 152 relative to the enclosure 110 (e.g., +/−X-direction) due to the varying magnetic field generated by the coil 155 reacting against the static magnetic field provided by the permanent magnet 157.

The amplifier assembly 115 may comprise a processor 118 coupled to input/output (I/O) devices 116, a power source 130 (e.g., battery) and a memory unit 122. Memory unit 122 may include one or more software applications 124. Processor 118 may be a hardware unit or combination of hardware units capable of executing software applications and processing data, which may, for example, include delivery of audio information from the speaker 150. In some configurations, the processor 118 includes a central processing unit (CPU), a digital signal processor (DSP), an application-specific integrated circuit (ASIC), and/or a combination of such units. Processor 118 is generally configured to execute the one or more software applications 124, which are each included within memory unit 122. Memory unit 122 may be any technically feasible type of hardware unit configured to store data. For example, memory unit 122 could be a hard disk, a random access memory (RAM) module, a flash memory unit, or a combination of different hardware units configured to store data. Software application 124, which is stored within the memory unit 122, includes program code that may be executed by processor 118 in order to perform various functionalities associated with the speaker assembly 100. The I/O devices 116 are coupled to memory unit 122 and may include devices capable of receiving input and/or devices capable of providing output. For example, I/O devices 116 is coupled to the speakers 150 that are configured to generate an acoustic output. I/O devices 116 may also include one or more transceivers configured to establish one or more different types of wired or wireless communication links with other transceivers residing within other computing devices in the external region 102, such as a transceiver within a smart phone, portable computer, tablet or other useful electronic device.

In some configurations, a sealing feature 160 is coupled to the one or more walls 111 so that the acoustic region 103 can be substantially isolated from the internal region 101 and the external region 102 when the feature surface(s) 161 are positioned against a surface 91 of a user 90. In one example, the surface 91 of the user 90 may include a surface 93A of the ear canal 93 of the user's ear (e.g., earbud configuration), a surface region 95 found around the ear 94 (e.g., headphone configuration) or even a surface 96 of the user's ear 94. The sealing feature 160 generally includes a compressible and/or flexible material that is able to form a seal against a surface of the user 90 that is typically non-flat. As noted above, the seal may be formed against a surface of the user that is found within the ear canal 93 and/or is on or surrounds a portion of the user's ear 94. In one configuration the feature surface 161 is adapted to be pressed against the surface region 95 of the user 90, by use of a headset element (not shown) that is configured to apply a pressure to both sides of a user's head. In some embodiments, the sealing feature may include an elastomer, plastic, foam, fabric/woven or other compliant material that is able to sealably enclose the acoustic region 103 and form a reliable seal with a surface of the user. In one example, the sealing feature 160 includes a silicone material, or fabric or woven material that may have a coating on one or more sides (e.g., polyurethane coating).

FIG. 2 is a side cross-sectional view that illustrates another configuration of an active speaker assembly 200, according to an embodiment of the disclosure provided herein. The active speaker assembly 200 is similar to the active speaker assembly 100 illustrated in FIG. 1, but additionally contains a plurality of ports that are used to fluidly connect the various isolated regions together, such as the internal region 101, external region 102 and acoustic region 103, to help reduce distortion, improve the sound quality and/or in some cases prevent discomfort to the user during operation of the device. In this configuration, the speaker enclosure 210 (or transducer enclosure) includes one or more walls 211 that enclose the internal region 101. The speaker enclosure 210 also includes one or more inner walls 212 that divide the internal region 101 into an inner region 201A and an outer region 201B. The inner walls 212 are generally used to further isolate the speaker 150, which is positioned within the inner region 201A, from the external region 102, and thus improve the sound quality of the speaker assembly 200.

In one embodiment, a restrictive port 234 is disposed through a portion of the inner wall 212 to fluidly connect the inner region 201A and the outer region 201B. During device operation, the restrictive port 234 is generally configured to allow any slow changing gas pressures generated by the mode damped diaphragm 152 to be relieved (e.g., low frequency generated pressures), while allowing rapidly changing gas pressures generated over short periods of time by the mode damped diaphragm 152 movement to be substantially maintained to reduce distortion and improve sound quality. The restrictive port 234 may include one or more port elements 236 and a restrictive cap element 235 that is disposed over an opening formed by at least one of the port elements 236. In one example, the restrictive port 234 includes two port elements 236 and a restrictive cap element 233 that is disposed over one of the port elements 236. Each port element 236 may include an opening, such as a tube or simple hole in the inner wall 212, that is sized to at least partially restrict fluid movement between the inner region 201A and the outer region 201B. The restrictive port elements 236 may be formed during a molding process used to form the inner wall 212. While not illustrated in FIG. 2, in one embodiment, the restrictive port 234 includes at least two port elements 236 that extend between the inner region 201A and the outer region 201B. Thus, in one configuration, the restrictive port elements 236 each have a length 234B and an inner diameter 234A that are designed to at least partially restrict fluid movement through the opening formed between the inner region 201A and the outer region 201B. In one example, a restrictive port element 236 has a length 234B of between about 0.5 and about 40 millimeters (mm) and an inner diameter 234A of between about 0.1 and about 12 millimeters (mm).

The restrictive cap element 235 will typically include a porous material that is configured to further restrict the fluid movement between the inner region 201A and the outer region 201B. The restrictive cap element 235 generally has a desired thickness, average pore size, exposed area (e.g., diameter of the restrictive port element 236) and pore density (or pore volume), so that a low audio distortion and improved sound quality is produced by the speaker assembly 200. One will note that pore size, pore density, thickness and exposed area all affect the selection of a desired restrictive cap element 235 that will produce an improved sound quality. In one example, the restrictive cap element 235 may include a foam material, a porous plastic material, fabric material, woven material or other useful non-solid material that is configured to restrict fluid movement through its cross-section. The restrictive cap element 235 material may include a sheet of a woven material that may be formed from a polyester, polyamide, polypropylene, other similar material. In some configurations, the porous restrictive cap element 235 may include a porous foam material or porous PTFE material that has an average pore size of between about 4 micrometers (μm) and about 50 μm, such as an average pore size in the range of between 5 and 15 μm, and has a cross-sectional thickness of about 0.5 mm.

The speaker assembly 200 may also include an outer restrictive port 231 that is disposed through a portion of the wall 211 to fluidly connect the internal region 101 and the external region 102. In one configuration, the outer restrictive port 231 is disposed through a portion of the wall 211 to fluidly connect the outer region 201B and the external region 102. The outer restrictive port 231 may include one or more openings 232, such as a tube or a simple hole in the wall 211, that are each sized to restrict fluid movement between the internal region 101 and the exterior region 102. The openings 232 may be formed during a molding process used to form the wall 211. In one configuration, each of the openings 232 are similarly configured as the port element 236, and thus has a length and an inner diameter that is specifically designed to provide a desired restriction to the fluid movement between the internal region 101 and the exterior region 102. The physical attributes (e.g., diameter and length) of each of the openings 232 may be the same as the restrictive port element 236, but in some cases may be different. The outer restrictive port 231 may also include a restrictive cap element 233 that is disposed over an opening formed by one or more of the port elements 231. In one example, the outer restrictive port 231 includes two openings 232 and a restrictive cap element 233 that is disposed over one of the openings 232. The restrictive cap element 233 may be similarly configured as the restrictive cap element 235, and will generally include a porous material that is configured to restrict the fluid movement between the internal region 101 and the exterior region 102.

The speaker assembly 200 may also include a central restrictive port 239 that is disposed through a portion of the wall 211 to fluidly connect the internal region 101 and the acoustic region 103. In one configuration, the central restrictive port 239 is disposed through a portion of the wall 211 to fluidly connect the inner region 201A and the acoustic region 103. The central restrictive port 239 may include one or more openings 238, such as a tube or a simple hole, that is sized to restrict fluid movement between the inner region 201A and the acoustic region 103. In one configuration, each of the openings 238 are similarly configured as the port elements 236, and thus has a length and an inner diameter that is specifically designed to provide a desired restriction to the fluid movement between the inner region 201A and the acoustic region 103. The physical attributes of each of the openings 238 may be the same as the restrictive port element 236, but in some cases may be different. The openings 238 may be formed during a molding process used to form the wall 211. The central restrictive port 239 may also include a restrictive cap element 237 that is disposed over an opening formed by one or more of the openings 238. In one example, the central restrictive port 239 includes two openings 238 and a restrictive cap element 237 that is disposed over one of the openings 238. The restrictive cap element 237 may be similarly configured as the restrictive cap element 235, and will generally include a porous material that is configured to restrict the fluid movement between the inner region 201A and the acoustic region 103.

Optionally, in some configurations, an audio restrictive port 240 may be formed to restrictively connect the acoustic region 103 and the external region 102 to avoid any discomfort that may be experienced by the user when a completely sealed acoustic region 103 is formed. In one configuration, the audio restrictive port 240 is disposed through a portion of the wall 211 to fluidly connect the acoustic region 103 and the external region 102. The audio restrictive port 240 may include one or more openings 242, such as a tube or simple hole in the inner wall 211, that is sized to restrict fluid movement between the acoustic region 103 and the exterior region 102. The openings 242 may be formed during a molding process used to form the wall 211. The audio restrictive port 240 may also include a restrictive cap element 241 that is disposed over one or more of the openings formed by the opening 242. The restrictive cap element 241 may be similarly configured as the restrictive cap element 235, and will generally include a porous material that is configured to restrict the fluid movement between the external region 102 and the acoustic region 103.

### Mode Damped Diaphragm

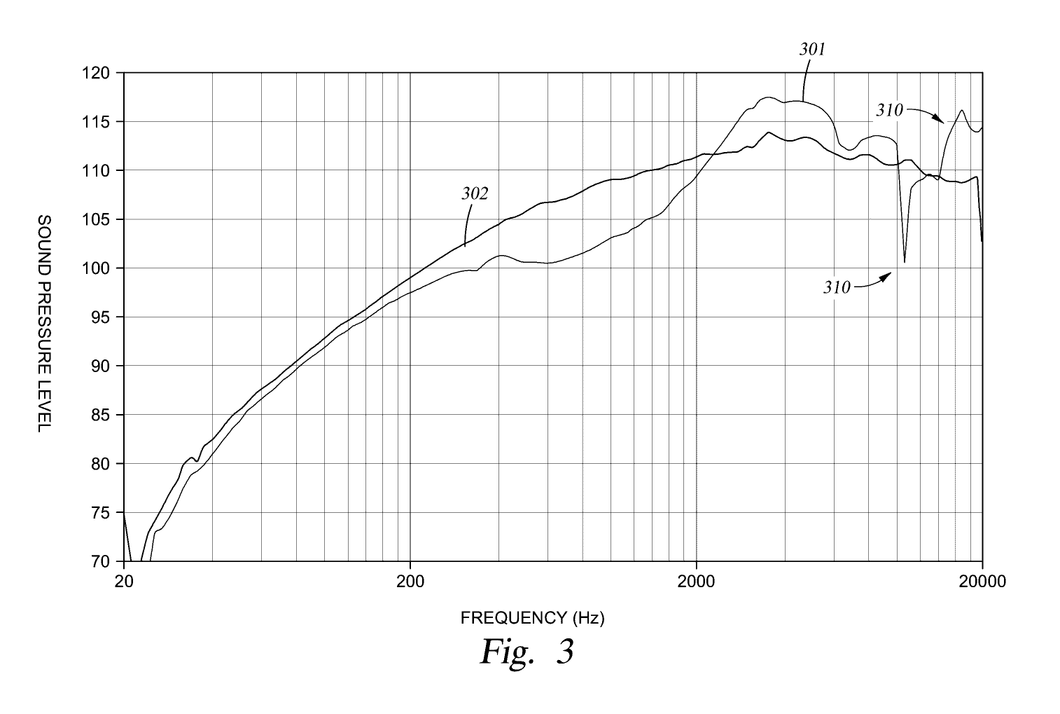

In an effort to provide a sealed active speaker assembly that is able to deliver an audio output that has a desirable sound quality, one or more embodiments of the disclosure utilize a mode damped diaphragm 152 to generate an audio output that is configured to faithfully reproduce sound across the full audio frequency range. Embodiments of the disclosure provided herein are adapted to improve the acoustic performance of an active speaker assembly that provides a smooth audio amplitude curve over the full frequency range. In general, the audio frequency range will include the speaker's desired acoustic range, which may include frequencies greater than 20 Hz, such as frequencies between 20 Hz and 100 kHz. In some audio speaker assembly configurations, such as headphone configurations, the primary (or desired) acoustic range is between 20 Hz and 20 kHz. During audio play back the desired acoustic range may be divided into two separate regions, which, among others, could include the “piston region” (e.g., frequencies <1000 Hz) and the “distortion prone” (or “breakup region”) (e.g., frequencies >3,000 Hz). The piston region of the diaphragm's driven frequency spectrum is generally found when the surface of the diaphragm 152 is operating as a whole, or solid unbending structural element, and thus producing a positive acoustic pressure in relation to positive electrical input at any given moment in time. The breakup region, as illustrated in FIG. 3 by the high frequency end of the conventional diaphragm curve 301 and the mode damped diaphragm curve 302, generally contains a part of a diaphragm's driven frequency spectrum where the surface of the diaphragm 152 tends to bend or deform in ways that create distortion. FIG. 3 illustrates a plot of the on-axis frequency response of a driver (e.g., dB SPL) as a function of frequency for a conventional diaphragm made from a solid or homogeneous sheet of material and a similarly sized mode damped diaphragm 152 that is formed from a non-solid or non-homogeneous sheet of material. In the example shown in FIG. 3, the conventional solid diaphragm included a 25 micrometers (μm) thick polyethylene terephthalate (PET) material that was about 40 mm in diameter, and the mode damped diaphragm 152 was a monofilament containing coated woven polyethylene terephthalate (PET) material that was about 50 μm thick and about 40 mm in diameter.

It is believed that when the wavelength of the acoustic output of a speaker assembly, or driver, is smaller than four times a driven diaphragm's diameter, parts of the diaphragm move out of phase with each other at the same moment in time. The out of phase movement will tend to cause partial and irregular cancellation of the total acoustical output generated by the diaphragm's surface. The distortion of the diaphragm causes localized cancellation which subtracts from the total acoustic power that can be generated by the speaker assembly. The distortion is believed to occur at all amplitudes and at varying physical angles relative to the center axis of the driver (e.g., X-direction in FIGS. 1-2). The distortion of the diaphragm can be visualized for example by sharp discontinuities in the acoustic transfer function above the transition frequency between the “piston range” and the “breakup region.” Above the transition frequency the total sound power of rigid diaphragm radiators decreases by 6 dB per octave. In one example, the transition frequency may be between about 2 kHz and 3 kHz, and the sharp discontinuities in the frequency response can be seen by the peaks 310 illustrated in the conventional diaphragm curve 301 shown in FIG. 3. It has been found that audio speaker 100 configurations that have a driver diaphragm that is smaller than about 60 mm in diameter (e.g., 5-60 mm) will especially benefit from the mode damped diaphragm design described herein. In one example, the driver diaphragm within the audio speaker 100 is between about 15 mm and about 60 mm in diameter, such as between about 16 mm and about 40 mm in diameter.

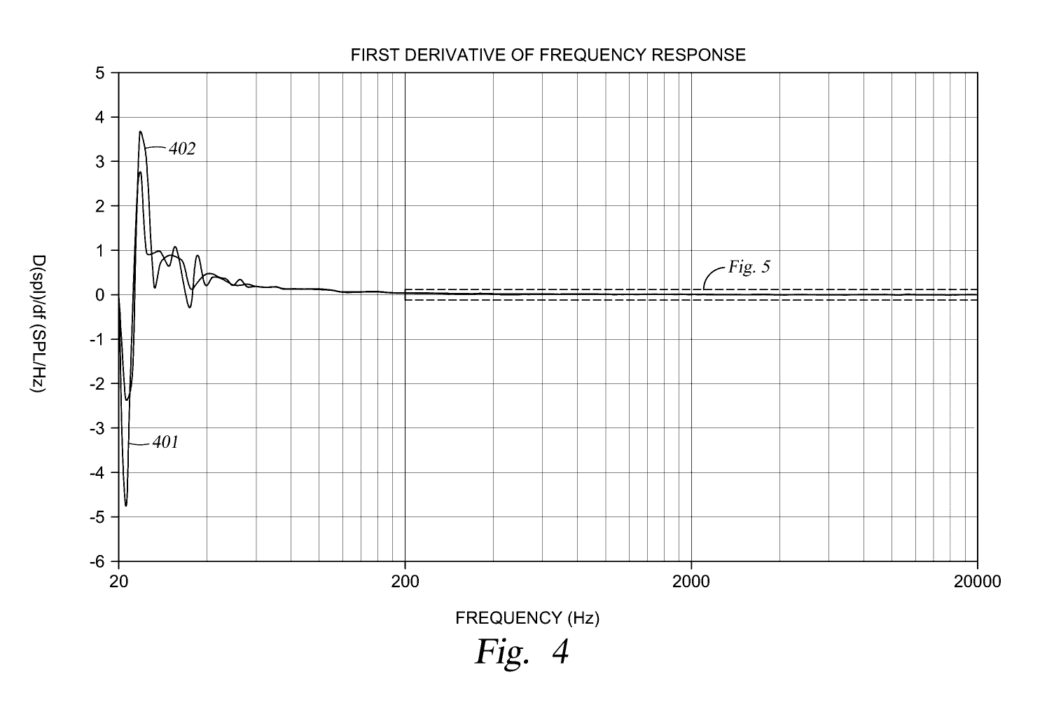

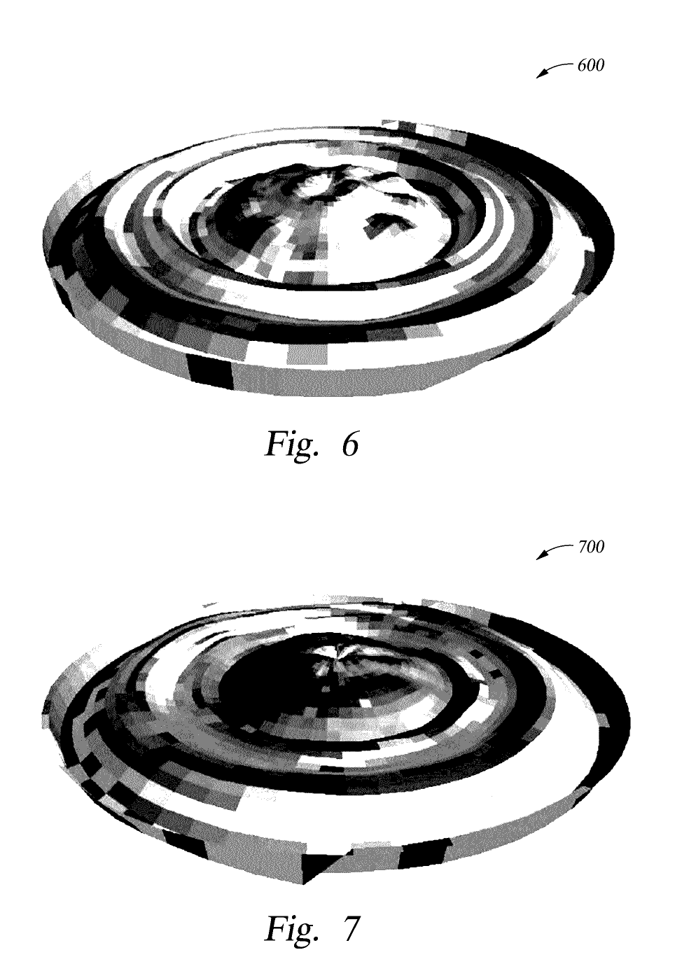

FIG. 6 illustrates a 3D surface laser vibrometer measurement of a conventional diaphragm in a conventional transducer in free-air at a driven frequency of 10 kHz. Alternately, FIG. 7 illustrates a 3D surface laser vibrometer measurement of a mode damped diaphragm in free-air at a driven frequency of 10 kHz. One will note the significant amount of physical diaphragm distortion found in the conventional diaphragm 600, due to the deformation of the conventional diaphragm material at a 10 kHz frequency. However, one will note the significant decrease in the distortion of the mode damped diaphragm 700 illustrated in FIG. 7, which was performed under the same test conditions and at the same frequency as the diaphragm shown in FIG. 4.

For most headphone type speaker assemblies, the distortion of the diaphragm can happen very abruptly in the frequency response curve causing high Q peaks and dips in the amplitude response at the given frequency. Unfortunately, the abrupt changes in the frequency response curve can happen within the normal listening band for audio, which is found in the desired acoustic range of a speaker assembly of between 20 Hz and 20 kHz. Not intending to be bound by theory, the modal distortion of the diaphragm happens regardless of diaphragm material, and is believed to be based solely on a diaphragm's physical properties, such as its dimensions. However, as discussed further below, the magnitude of the distortion of the mode damped diaphragm can be reduced by tailoring its dynamic and mechanical properties, and also by additionally restricting the movement of a fluid (e.g., air) between the various speaker assembly regions of the speaker assembly (e.g., internal region 101, external region 102 or acoustic region 103).

While one cannot completely prevent the distortion of the diaphragm from occurring, embodiments of the disclosure provided herein have been selected so that they can control and minimize the amount that the diaphragm distortion that will affect the frequency response of the speaker assembly, as illustrated by the mode damped diaphragm curve 302 shown in FIG. 3. Due to the mode damped diaphragm's reduced distortion, a smoother spectral balance is provided in the acoustical output of the speaker assembly. The smoother transition, provided by the smoother spectral balance, also makes it possible to effectively use amplitude equalization to the driver's response. However, sharp discontinuities in the response, as seen in the conventional diaphragm curve 301, cannot effectively be corrected through amplitude equalization. It has been found that the mode damped diaphragm 152 will also provide a smoother Directivity Index and smoother Sound Power response.

In some embodiments of the disclosure, the mode damped diaphragm includes a non-homogeneous material (woven monofilament network) that is able to minimize the impact of the frequency induced distortion of the diaphragm, or breakup modes, when compared to common homogeneous diaphragm materials. In some embodiments, the mode damped diaphragm 152 includes a fiber containing sheet of a thermoplastic polymer material, such as polyethylene terephthalate (PET), polyethylene (PE), or polypropylene (PP) material may be used. In some embodiments, the mode damped diaphragm 152 may also include a woven thermoplastic polymer material that is formed using a thin monofilament that is woven into a single layer (or ply) mesh network, thereby presenting an orthogonal, anisotropic, and non-homogeneous material. In one example, the mode damped diaphragm 152 includes a monofilament containing woven or pressed polyethylene terephthalate (PET) material. In some configurations, the raw woven material is heat formed or molded in a thermal press to form a desired shape in the surface of the mode damped diaphragm 152.

In general, the mode damped diaphragm 152 is configured so that the reproduction of frequencies lower than the transition frequency (e.g., piston region) the diaphragm gets its rigidity from the 3D heat formed or stamped shape. However, for frequencies above the transition frequency the woven network of monofilaments does not have the same rigidity as conventional solid diaphragms. The selection of a fiber containing thermoplastic material will cause the rigidity of the mode damped diaphragm 152 to be reduced over conventional solid diaphragm designs, allowing mode damped diaphragm 152 to flex to a greater extent than standard homogeneous diaphragm found in most conventional designs. The increased flexibility of the mode damped diaphragm 152 is used to damp, and thereby reduce, the negative effects of the distortion at frequencies greater than the piston region. One skilled in the art will appreciate that the selection of a fiber containing thermoplastic material that has an increased flexibility is the opposite of what conventional audio speaker designs had used to resolve the frequency induced distortion of the diaphragm. In most conventional designs, speaker designers had sought to form a conventional diaphragm from a very stiff or rigid material, such as beryllium (Be), in an effort to try to shift the discontinuities in the frequency response curve to frequencies that are outside of the desired audio frequency range of the speaker. The use of these very stiff or rigid materials greatly increased the material and manufacturing costs required to form a conventional diaphragm, due to the need to use exotic materials such as titanium, aluminum and beryllium, and also makes the magnitude of the distortion greater.

Typically, in a headphone driver application, there is a compromise between the need for absolute rigidity of the center of the diaphragm and the need for compliance in the surround part of the diaphragm. In typical loudspeaker configurations, the diaphragm is a separate part from the surround. However, in some embodiments used in headphone type applications, the mode damped diaphragm and surround (e.g., surround 156 in FIGS. 1-2) are formed from the same material. Therefore, in some configurations, the mode damped diaphragm 152 may have a stiff/rigid center dome and also act as a compliant surround so as not to restrict the diaphragm's movement. In one embodiment, the mode damped diaphragm 152 may include a first material that is woven, and the weave of the woven material extends between edge regions that are coupled to the frame 154, wherein the edge regions are on opposite sides of a central region of the mode damped diaphragm. In this case, the speaker assembly 100 or 200 (FIG. 1 or 2) may be formed without a dedicated surround 156. In one embodiment, the mode damped diaphragm 152 may include a first material that is woven, and the weave of the woven material extends between an edge region that is coupled to the frame 154, or surround 156, and to a central region of the mode damped diaphragm that is coupled to a voice coil 155.

In some configurations, multiple different types of fiber materials and/or woven material patterns may be used together to form the mode damped diaphragm 152. In some configurations, the filament strands may contain a coating that when heated and pressed flow together to form an air tight seal between the opposing sides to the mode damped diaphragm 152. The end result is a reduction of the impact of the transition between the piston region and the breakup region of the acoustic spectrum. The heat forming process can be used to form a biaxially-oriented diaphragm by secondary processes to improve its isotropic properties. The heat forming process performed on the mode damped diaphragm can improve its dimensional stability and allow a diaphragm having a complex shape to be formed.

While not intending to be bound by theory, in some configurations the material that is used to form the mode damped diaphragm 152 is selected so that a significant portion modal distortion is reduced by the proper selection of a material that has desirable mechanical properties. The modulus of elastic modulus (E′), mass density (p), speed of sound (c) and Poisson's ratio (v) of the material that is used to form the mode damped diaphragm 152 is selected to assure that modal distortion previously observed during normal operation are substantially mechanically damped. The mode damped diaphragm 152 may include a material that has a modulus of elasticity (E′) that is less than about 2 gigapascals (GPa). In some embodiments, the mode damped diaphragm 152 includes a material that has a modulus of elasticity (E′) that is less than about 1 gigapascals (GPa). In one example, the mode damped diaphragm 152 is PET material that has a modulus of elasticity (E′) and Poisson's ratio of about 0.51 gigapascals (GPa) and 0.404, respectively. In one example, the mode damped diaphragm 152 includes a material that has a stiffness (k) of about 0.1339 N/mm and a mass density (p) of about 820 kg/m³, and also a resonant frequency (f) of about 7.08 Hz and quality factor (Q) of about 7.33. In comparison, standard conventional diaphragms that are formed from a solid PET material (e.g., shown in FIG. 3), typically have a modulus of elasticity (E′), and mass density of about 2.43 gigapascals (GPa) and 1278 kg/m³, respectively, and have a resonant frequency (f) of about 6.18 Hz and quality factor (Q) of about 5.46. Conventional diaphragm design rules would greatly favor the use of the conventional diaphragm material formed from solid PET due to its 475% greater modulus of elasticity, 87% lower resonant frequency and/or 75% lower quality factor, as discussed above.

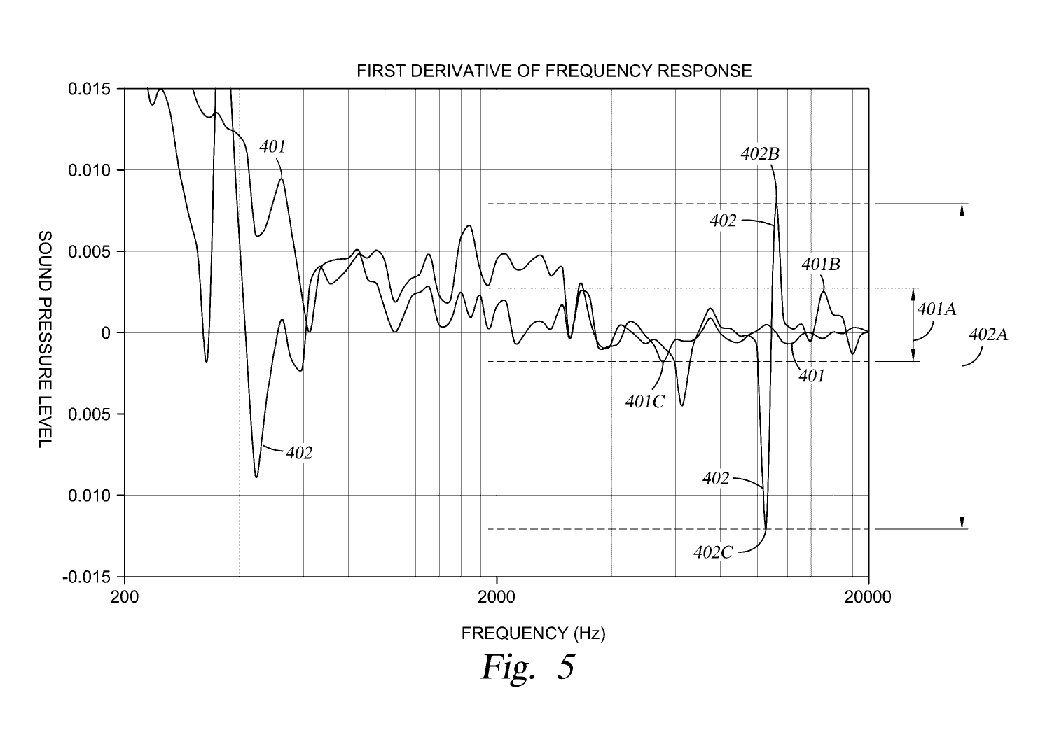

FIGS. 4 and 5 are graphs of the first derivative (e.g., d(SPL)/df) of the audio output data generated from the conventional audio speaker and the mode damped diaphragm speaker assembly shown in FIG. 3, according to an embodiment of the disclosure provided herein. FIGS. 4 and 5 are provide to graphically illustrate the difference in the acoustic performance of a conventional audio speaker and the mode damped diaphragm speaker assembly by illustrating the relative change in slope (e.g., first derivative) in the acoustic output when using a convention diaphragm design and the mode damped diaphragm design. The smaller the variation in the first derivative of the acoustic output (e.g., SPL versus frequency), the smaller the effect that the frequency induced mode distortion(s) have on the acoustic output of a diaphragm, and thus the better the audio speaker's sound quality will be over the generated frequency range. The first derivative data can thus be used to determine whether a diaphragm has one or more significant modal distortions which affect the generated sound quality of the audio speaker 100. One will note that the first derivative data shown in FIGS. 4 and 5 was measured for the conventional audio speaker and the mode damped diaphragm speaker assembly using the standard ISO R40 preferred sampling frequencies.

FIG. 4 illustrates the first derivative with respect to frequency of the audio output data generated from the conventional audio speaker and the mode damped diaphragm type speaker assembly shown in FIG. 3 over the primary acoustic range (e.g., between 20 Hz and 20 kHz). One will appreciate that the first derivative can be measured by determining the change in the sound pressure level (SPL) divided by the change in frequency over the measurement period, or

$$\frac{\partial ( SPL )}{\partial f} \approx \frac{Δ ( SPL )}{Δ ( freq . )} = \frac{( SPL 2 - SPL 1 )}{( freq .2 - freq .1 )} , \qquad ( Equation 1 )$$

where SPL₁ is measured at a first frequency point and SPL₂ is measured at a second frequency point. The first derivative of the acoustic output of the mode damped diaphragm is illustrated by curve 401, and the first derivative of the acoustic output of the conventional audio speaker is illustrated by curve 402. The change in slope of the acoustic output in the “piston region” tends to dominate the change in slope found in the “distortion prone” region, due to the large fluctuations in both the SPL curves 401 and 402 at very low frequencies.

FIG. 5 illustrates the first derivative with respect to frequency of the audio output data generated from the conventional audio speaker and the mode damped diaphragm type speaker assembly shown in FIG. 3 within the “distortion prone” region (or “breakup region”), which is generally between 2-3 kHz and 20 kHz. The peak-to-peak variation in the mode damped diaphragm's curve 401 is defined by the upper peak 401B and the lower peak 401C, while the peak-to-peak variation in the conventional speaker's curve 402 is defined by the upper peak 402B and the lower peak 402C. Due to the non-rigid and internal damping properties of the material used to form the mode damped diaphragm the peak-to-peak variation 401A of the first derivative is typically about 0.007 dB(SPL)/Hz within the 2000-20,000 Hz range, while the peak-to-peak variation 402A of the first derivative of the conventional speaker's curve was about 0.019 dB(SPL)/Hz within the 2000-20,000 Hz range, or about 2.8 times larger than the mode damped diaphragm's peak-to-peak variation, when calculated using data collected at an ISO R40 frequency sampling interval. In another example, the first derivative range was found to be about 0.020 dB(SPL)/Hz for the mode damped diaphragm within the 2000-20,000 Hz range, while the peak-to-peak variation of the first derivative of the conventional speaker was about 0.079 dB(SPL)/Hz within the 2000-20,000 Hz range, or about 4.0 times larger than the mode damped diaphragm's peak-to-peak variation, when calculated using data collected at a sampling interval that included 2000 data points between the frequencies 1 kHz and 45 kHz. Therefore, by selecting and forming a mode damped diaphragm 152 that has desirable internal damping, structural and material properties (e.g., thickness, density, Poison's ratio, tensile modulus (E′), loss modulus (E″) for a desired diaphragm diameter) the mode damped diaphragm's acoustic performance will generally have a substantially lower modal distortion free acoustic output over the primary acoustic range, as shown in FIGS. 3-5. Therefore, in some embodiments, the mode damped diaphragm is formed such that the peak-to-peak variation in the first derivative of the acoustic output curve (i.e., SPL vs. frequency curve) is desirably less than about 0.007 dB(SPL)/Hz within the 2000-20,000 Hz range, when calculated using data collected at an ISO R40 frequency sampling interval. In another embodiment, the mode damped diaphragm is formed such that the peak-to-peak variation in the first derivative of the acoustic output curve (i.e., SPL vs. frequency curve) is desirably less than about 0.020 dB(SPL)/Hz within the 2000-20,000 Hz range.

In some embodiments, the mode damped diaphragm 152 includes a diaphragm layer 152A and an optional coating layer 152B that are configured to help sealably enclose a portion of the interior region 101. The diaphragm layer 152A may include a structural material that has desirable material properties. The optional coating layer 152B includes a material (e.g., polymer) that is used to coat a surface of the mode damped diaphragm 152 to assure that air or a liquid will not pass through the mode damped diaphragm. In some embodiments, it is desirable to select a coating layer that is configured to alter the dynamic properties of the diaphragm, such as its mechanical damping properties. In one embodiment, a polymer and/or metal containing material is deposited on a surface of the mode damped diaphragm 152 to alter the properties of the diaphragm. In one example, the coating layer 152A includes at least one material selected from the group consisting of a phenol formaldehyde resin, styrene butadiene rubber (SBR) and polyurethane material. In another example, a metal containing coating, such as a nickel containing material, is vapor deposited on a PET woven monofilament containing mode damped diaphragm 152.

In some embodiments, the fiber containing thermoplastic material used to form the mode damped diaphragm 152 is used in conjunction with additional layers of a material that are intended to additionally dampen the effects of the diaphragm distortion during operation. In this configuration, a composite diaphragm will be formed which includes two or more individual layers that are positioned next to each other or bonded together to form the mode damped diaphragm 152. In one example, the mode damped diaphragm 152 includes a plurality of fiber containing thermoplastic material layers, such as woven PET containing layers that are bonded together.

In some embodiments of the mode damped diaphragm 152, the fiber containing thermoplastic material may also be positioned on a conventional diaphragm material to improve the acoustic properties of the conventional diaphragm design. It is believed that this hybrid structure can improve the performance of a conventional diaphragm design. In some configurations, the hybrid structure may include sections or regions of the diaphragm where the fiber containing thermoplastic material is disposed on only a part of the total diaphragm area. In this case, the other sections may simply include a conventional driver diaphragm material. In some cases, multiple types of dissimilar materials could be positioned over regions of the conventional diaphragm material, such as solid stamped metals, compressed closed or open cell foams, vapor deposited metals, injection molded, or other desirable material. In one example, the fiber containing thermoplastic material is a subsection of a single composite driver, such as where the fiber containing thermoplastic material diaphragm is inset in a coaxial and coincident arrangement with a standard diaphragm material that extends from the outer edge of the fiber containing thermoplastic material to the outer edge of the speaker.

In some embodiments, the active speaker assembly 200 may include two speakers that each contain different types of diaphragms to improve the overall sound quality generated by the complete speaker assembly. In one configuration, a first speaker includes a mode damped diaphragm 152 and a second speaker contains a conventional speaker diaphragm material. In this case, the mode damped diaphragm 152 could be used as the high frequency driver, while a conventional diaphragm could be used as the low frequency driver, or vice versa.

In some embodiments, the mode damped diaphragm 152 and one or more of the restrictive ports 231, 234, 239 or 240 of the speaker assembly 100, 200 are used in conjunction with each other to achieve an audio output that has low distortion and a desirable sound quality across the full audio frequency range. Embodiments of the disclosure provided herein thus may include a mode damped diaphragm 152 that has material properties that when combined with the ability of one or more of the restrictive ports to control the flow of air between one or more of the speaker assembly regions (e.g., internal region 101, external region 102 or acoustic region 103) is able to provide a smooth audio amplitude curve over at least the breakup region of the acoustic range, and in some cases over the full frequency range.

In some embodiments, the active speaker assembly 200 includes at least a plurality of restrictive ports 234 and a plurality of central restrictive ports 239 to help reduce distortion, improve the sound quality and/or in some cases prevent discomfort to the user during operation of the active speaker assembly, which contains the mode damped diaphragm 152 that has a diameter that is less than about 60 mm (e.g., 15-60 mm). In one example, the mode damped diaphragm 152 containing active speaker assembly 200 includes at least two or more restrictive ports 234 and two or more central restrictive ports 239. In another embodiment, the mode damped diaphragm 152 containing active speaker assembly 200 includes at least one outer restrictive port 231, at least two or more restrictive ports 234, two or more central restrictive ports 239 and at least one audio restrictive port 240. In some embodiments, the outer restrictive ports 231, the restrictive ports 234, the central restrictive ports 239 and the audio restrictive port 240 may be between 0.5 mm and 10 mm in diameter and have a length between about 1 mm and 25 mm.

Referring back to FIG. 2, the two or more restrictive ports 234 may include a first type of restrictive port that is between about 2 mm and about 4 mm in diameter (e.g., 234A) and is between about 12 and about 17 mm long (e.g., 234B), with no restrictive cap element 235 covering the port element 236, and/or a second type of restrictive port that is between about 2 and about 4 mm in diameter (e.g., 234A) and is between about 1 and about 2 mm long (e.g., 234B), and having a restrictive cap element 235 disposed thereover, to control the acoustic pressure generated in the inner region 201A. The first type of restrictive ports may have an aspect ratio (e.g., diameter/length ratio) of between about 0.12 and about 0.25, and the second type of restrictive ports may have an aspect ratio of between about 1 and about 4. In some embodiments, the restrictive ports 234 may have an aspect ratio of between about 0.12 and about 4.

The two or more central restrictive ports 239 may include a first type of central restrictive port that is between 2 and about 4 mm in diameter and is between about 1 and about 2 mm long, with a restrictive cap element 237 covering the first type of central restrictive port, and/or a second type of restrictive port that is between about 0.5 and about 1.5 mm in diameter and is between about 1 and about 2 mm long, and having a restrictive cap element 237 disposed thereover, to control the acoustic pressure generated in the acoustic region 103. The first type of central restrictive ports may have an aspect ratio of between about 1 and about 4, and the second type of central restrictive ports may have an aspect ratio of between about 0.25 and about 1.5. In some embodiments, the central restrictive ports 239 may have an aspect ratio of between about 0.25 and about 4.

In some embodiments, the mode damped diaphragm 152 containing active speaker assembly 200 may also include at least two or more outer restrictive port 231 (e.g., 3-12 outer restrictive ports 231) that may be between 2 and about 4 mm in diameter and is between about 1 and about 2 mm long. The outer restrictive port 231 may have an aspect ratio of between about 1 and about 2 to control the movement of air between the outer region 201B and the external region 102, which can affect the acoustic pressure and/or rate of change of the acoustic pressure generated in the inner region 201A by the mode damped diaphragm 152.

In one configuration of the active speaker assembly 200, two or more of the first type of restrictive ports 234, between six and ten of the second type of restrictive ports 234, at least one of the first type of central restrictive ports 239, and two or more of the second type of the central restrictive ports 239 are utilized in an active speaker assembly. In this example, the restrictive ports 234 and 239 may be especially useful for providing a desirable sound quality when used in a configuration where a monofilament containing woven driver material has a diameter of about 30-50 mm, the acoustic region 103 has a volume of about 90-110 cubic centimeters (ccs), the inner region 201A has a volume of about 10-15 ccs, and the outer region 201B has a volume of about 80-120 ccs. Without being bound by theory, it is believed that an active speaker assembly 200 that includes a flexible mode damped diaphragm 152 and one or more restrictive ports 231, 234, 239 and/or 240 as described above, such as two or more of each of the ports 231, 234 and 239, can achieve an audio output that has low distortion and a desirable sound quality across the full audio frequency range due to the provided restriction and control of the movement of air between the volumes enclosed by the acoustic region 103, inner region 201A, outer region 201B and external region 102 provided by the ports.

While the foregoing is directed to embodiments of the present disclosure, other and further embodiments of the disclosure may be devised without departing from the basic scope thereof, and the scope thereof is determined by the claims that follow.

We claim:

1. An audio speaker assembly, comprising:
an enclosure comprising one or more first walls that at least partially enclose a first internal region;
a sealing feature that is coupled to the enclosure, and having a sealing surface that forms an enclosed acoustic region when placed in contact with at least a portion of a user; and
a speaker that is coupled to the one or more first walls, wherein the speaker comprises:
a mode damped diaphragm, wherein the mode damped diaphragm is disposed between the first internal region and the enclosed acoustic region; and
a voice coil that is configured to drive the mode damped diaphragm to generate an acoustic pressure in the enclosed acoustic region and the first internal region, wherein the voice coil and mode damped diaphragm are configured to deliver an acoustic output across a first acoustic range.

2. The audio speaker assembly of claim 1, wherein the enclosure further comprises:
one or more second walls, wherein the one or more first walls and the one or more second walls at least partially define a second internal region;
one or more first ports having an opening that extends through the one or more first walls, and the opening allows fluid communication between the enclosed acoustic region and the first internal region; and
one or more second ports having an opening that extends through the one or more second walls, and the opening allows fluid communication between the second internal region and first internal region.

3. The audio speaker assembly of claim 2, wherein the opening of the one or more first ports have an aspect ratio of between about 0.12 and about 4, and the opening of the one or more second ports have an aspect ratio of about 0.25 and about 4.

4. The audio speaker assembly of claim 1, wherein the mode damped diaphragm comprises a woven material.

5. The audio speaker assembly of claim 4, wherein the first acoustic range comprises frequencies from 20 Hz to 20,000 Hz.

6. The audio speaker assembly of claim 1, wherein the mode damped diaphragm comprises a first material that is woven, and the weave of the woven material extends between an edge region and a central region of the mode damped diaphragm.

7. The audio speaker assembly of claim 6, wherein the mode damped diaphragm further comprises a second material that is a sealing material that is applied to a surface of the first material.

8. The audio speaker assembly of claim 7, wherein the sealing material is a material selected from a group consisting of a phenol formaldehyde, styrene butadiene rubber (SBR) and polyurethane material.

9. The audio speaker assembly of claim 1, wherein the mode damped diaphragm comprises a first material having a modulus of elasticity of less than 2 GPa.

10. The audio speaker assembly of claim 1, wherein the mode damped diaphragm has a peak-to-peak variation in a first derivative of an acoustic output curve that is less than about 0.007 dB(SPL)/Hz within a frequency range of between about 2000 Hz and about 20,000 Hz.

11. An audio speaker assembly, comprising:
an enclosure comprising one or more walls that at least partially enclose a first internal region;
a sealing feature that is coupled to the enclosure, and having a sealing surface that forms an acoustic region when placed in contact with at least a portion of an ear of a user or a portion of the user surrounding the ear;
a port element that includes an opening formed through a first wall of the one or more walls, wherein the opening extends between a first side and a second side of the first wall;
a restrictive cap element that is disposed over the opening formed on the first side of the first wall; and
a speaker that is coupled to the one or more walls, wherein the speaker comprises:
a mode damped diaphragm, wherein the mode damped diaphragm is disposed between the first internal region and the acoustic region; and
a voice coil that is configured to drive the mode damped diaphragm to generate an acoustic pressure in the acoustic region and the first internal region, wherein the voice coil and mode damped diaphragm are configured to deliver an acoustic output across a first acoustic range.

12. The audio speaker assembly of claim 11, wherein the opening of the port element has an aspect ratio of between about 0.12 and about 4.

13. The audio speaker assembly of claim 12, wherein the restrictive cap comprises a porous material.

14. The audio speaker assembly of claim 11, wherein the mode damped diaphragm comprises a woven material.

15. The audio speaker assembly of claim 14, wherein the mode damped diaphragm comprises a first material having a modulus of elasticity of less than 1 GPa.

16. The audio speaker assembly of claim 15, wherein the first acoustic range comprises frequencies from 20 Hz to 20,000 Hz.

17. The audio speaker assembly of claim 11, wherein the mode damped diaphragm comprises a first material that is woven, and the weave of the woven material extends between an edge region and a central region of the mode damped diaphragm, and the mode damped diaphragm further comprises a second material that is a material that is applied to a surface of the first material.

18. The audio speaker assembly of claim 17, wherein the sealing material is a material selected from a group consisting of a phenol formaldehyde, styrene butadiene rubber (SBR) and polyurethane material.

19. The audio speaker assembly of claim 18, wherein the woven material comprises polyethylene terephthalate (PET).

20. The audio speaker assembly of claim 11, wherein the mode damped diaphragm has a peak-to-peak variation in a first derivative of an acoustic output curve that is less than about 0.007 dB(SPL)/Hz within a frequency range of between about 2000 Hz and about 20,000 Hz.
